(19) United States
(12) Patent Application Publication
(10) Pub. No.: US 2008/0118062 A1
(43) Pub. Date: May 22, 2008

(54) System, Methods, Apparatuses, and Computer Program Products for Providing a Private Multiple Screen

(75) Inventors: Zoran Radivojevic, Helsinki (FI); Johan Bergquist, Tokyo (JP); Tapani Levola, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/561,936

(22) Filed: Nov. 21, 2006

(51) Int. Cl. H04N 7/167

(52) U.S. Cl. 380/210

(57) ABSTRACT

An apparatus for providing a private multiple screen includes a signal modification element and a communication element. The signal modification element is configured to apply a privacy operation to an input video signal to produce a modified video signal. The communication element is in communication with the signal modification element and is configured to transmit security information to the receiving device to enable the receiving device to substantially restore the input video signal.

### TECHNOLOGICAL FIELD

Embodiments of the present invention relate generally to video display technology and, more particularly, relate to a system, methods, apparatuses and computer program products for providing a private video screen capable of serving multiple users.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to further increase the ease of information transfer and convenience to users relates to provision of video data to consumers. Video data and other multimedia information has become, for many people, a gateway to the external world. As such, display technology has become important since consumers are demanding increased quality from their video displays. This demand has caused rapid advancements in display technology capabilities. However, acquiring a large display having a high resolution may still require a large investment.

Accordingly, for both public environments, where it is desired to provide video information to large numbers of people, and private environments where, for example, a family may wish to have choices in program viewing without a requirement to purchase several displays, it may be desirable to find a way to serve multiple consumers video information without a corresponding increase in the number of displays for displaying the video information.

Additionally, many consumers value privacy while consuming video data. For example, it is common in public places for a user of a personal electronic device or mobile terminal such as a mobile telephone, PDA, gaming console, laptop computer, etc. to feel uncomfortable since numerous strangers may be able to view the display of the mobile terminal. Information displayed may have been intended to remain private and, in any case, many people value privacy regarding the information they consume.

Additionally, certain public venues provide displays for public consumption. For example, public displays at an airport, train or bus terminal may provide a large display showing a particular broadcast. Furthermore, semi-public displays at buses, car/taxi, railways, airplanes etc. may have the same basic features, e.g., just one content at a time for all the users watching the display. Such a display affords no choice to the public as to the content consumed and so many public venues provide multiple displays tuned to different broadcasts. However, even in such situations where multiple displays are utilized to provide a variety of programming options, there is no privacy afforded to the consumer.

Given the highly capable nature of currently available displays, such as active matrix displays, it may be desirable to provide a display capable of serving multiple programming options to consumers in a single display. Furthermore, it may be desirable to provide a display that is capable of serving either one or multiple users in a private or secure environment, even when such user or users are in a public place.

### BRIEF SUMMARY

A method, apparatus and computer program product are therefore provided for providing a private multiple screen. As such, either one or more users may privately consume video data corresponding to a single or even multiple video signals. Accordingly, a single display could be used to broadcast multiple channels of video data and users may be enabled to privately consume a desired channel. In this regard, embodiments of the present invention provide for modification of an input video signal and communication of security information related to the modification of the input video signal to a translation device. The translation device is able to utilize the security information to drive a display according to a substantial restoration of the input video signal by removing the modification inserted. In some embodiments, the users could subscribe to one or more channels in order to have access to security information which enables viewing of the corresponding channels.

In one exemplary embodiment, a method of providing a private multiple screen is provided. The method includes applying a privacy operation to an input video signal to produce a modified video signal, displaying, for receipt at a receiving device, a sequence of modified image frames corresponding to the modified video signal, and transmitting security information to the receiving device to enable the receiving device to substantially restore the input video signal.

In another exemplary embodiment, a computer program product for providing a private multiple screen is provided. The computer program product includes at least one computer-readable storage medium having computer-readable program code portions stored therein. The computer-readable program code includes multiple executable portions. The first executable portion is for applying a privacy operation to an input video signal to produce a modified video signal. The second executable portion is for displaying, for receipt at a receiving device, a sequence of modified image frames corresponding to the modified video signal. The third executable portion is for transmitting security information to the receiving device to enable the receiving device to substantially restore the input video signal.

In another exemplary embodiment, an apparatus for providing a private multiple screen is provided. The apparatus includes a signal modification element and a communication element. The signal modification element is configured to apply a privacy operation to an input video signal to produce a modified video signal. The communication element is in communication with the signal modification element and is configured to transmit security information to the receiving device to enable the receiving device to substantially restore the input video signal.

In another exemplary embodiment, an apparatus for providing translation of a private multiple screen is provided. The apparatus includes a communication interface, a processing element and a display. The communication interface is configured to optically receive a sequence of modified image frames and security information related to a privacy operation associated with the modified image frames. The processing element is in communication with the communication interface and is configured to translate the modified image frames to restored image frames corresponding to the modified image frames based on the security information. The display is for displaying the restored image frames. The display is in communication with the processing element.

In another exemplary embodiment, an apparatus for providing a private multiple screen is provided. The apparatus includes a display device configured to receive a modified video signal including an input video signal altered according to a privacy operation and to display, for optical receipt at a receiving device, a sequence of modified image frames corresponding to the modified video signal.

In another exemplary embodiment, an apparatus for providing translation of a private multiple screen is provided. The apparatus includes means for optically receiving a sequence of modified image frames, means for receiving security information related to a privacy operation associated with the modified image frames, and means for translating the modified image frames to restored image frames corresponding to the modified image frames based on the security information.

Embodiments of the present invention may be advantageously employed, for example, in resource constrained devices such as mobile terminals or goggles in order to provide a cost effective and portable mechanism by which private viewing of public screens may be accomplished. As such, private viewing of displays may be accomplished in automobiles, trains, buses, airplanes or in train terminals, bus terminals or airports. Additionally, viewers watching a single display may view different video streams.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a system for providing a private multiple screen according to an exemplary embodiment of the present invention;

FIG. 3 illustrates a schematic block diagram of elements of a translation device according to an exemplary embodiment of the present invention;

FIG. 4 illustrates a diagram of a series of pulses representing different bits in the gray scale in each frame of a video signal according to an exemplary embodiment of the present invention;

FIG. 5 shows a series of image frames of a modified video signal associated with an input image signal according to an exemplary embodiment of the present invention;

FIG. 6 shows a series of image frames of a modified video signal associated with more than one input image signal according to an exemplary embodiment of the present invention;

FIG. 7 shows a series of image frames of a modified video signal associated with more than one input image signal with additional privacy measures according to an exemplary embodiment of the present invention;

FIG. 8 is an illustration of a display employing pixel transformation according to an exemplary embodiment of the present invention;

FIG. 9 is a diagram illustrating synchronization of receiver operations with a signal including security information such as synchronization and timing information according to an exemplary embodiment of the present invention;

FIG. 10 illustrates pixel transformation according to an exemplary embodiment of the present invention;

FIG. 11 is a flowchart according to an exemplary method of providing a private multiple screen according to one embodiment of the present invention; and

FIG. 12 is a flowchart according to another exemplary method of providing a private multiple screen according to one embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

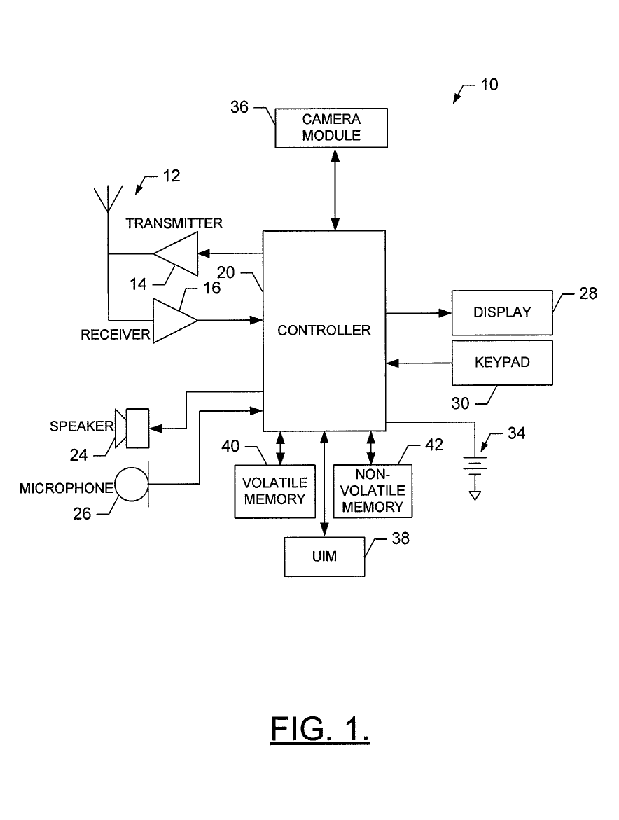

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While the mobile terminal 10 of FIG. 1 may be a mobile telephone, many other types of mobile devices may also benefit from embodiments of the present invention such as, for example, goggles or any other device through which visual images may be. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, and TD-SCDMA.

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example.

The mobile terminal 10 also comprises a user interface including an output device such as a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to a JPEG standard format.

The mobile terminal 10 may further include a universal identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

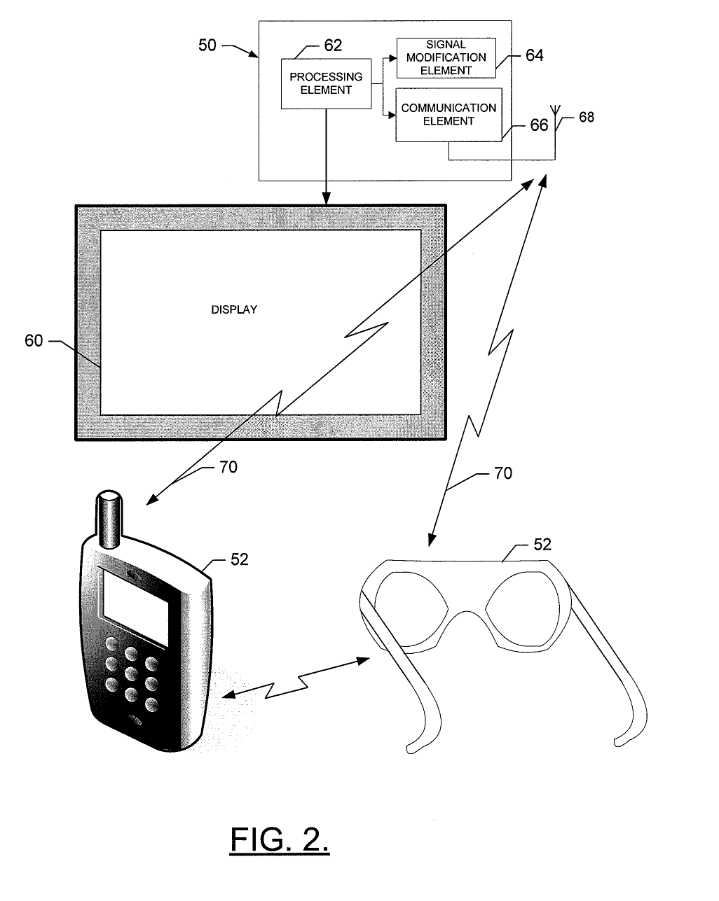

Referring now to FIG. 2, an illustration of one type of system that would benefit from embodiments of the present invention is provided. The system includes a display 60, a signal processing element 50 and a translation device 52. As shown, one or more translation devices 52 may be employed. The display 60 may be any suitable display device known in the art. In an exemplary embodiment, the display 60 may include any known active matrix display such as a liquid crystal display (LCD). However, it may be desirable to utilize a relatively high resolution display with a relatively high rate of refreshing. In alternative exemplary embodiments, the display 60 may be, for example, a privately owned television, a PC or laptop computer screen, a display screen in a personally owned vehicle, a movie theatre projection screen, an electronic billboard, or a public display in a public location such as a train or bus terminal, an airport or on a train, a bus, or an airplane. The display 60 may be substantially identical to any known display device in the art. In this exemplary embodiment, the display 60 is in communication with the signal processing element 50 which processes input signals and provides processed input signals to the display 60. The communication between the display 60 and the signal processing element 50 may be accomplished via any known mechanism including both wired and wireless communication.

The signal processing element 50 includes a signal modification element 64 and a communication element 66 which operate under the control of a processing element 62. The communication element 66 may include or otherwise be in communication with an antenna 68 which may communicate with the translation device 52 via a wireless link 70. The translation device 52 may be, for example, the mobile terminal 10 of FIG. 1 or goggles as also shown in FIG. 2. The wireless link 70 may be, for example, a cellular communication channel, a Bluetooth connection, or any other suitable wireless connection known in the art. For example, the wireless link 70 could be established by radio frequency (RF) or optical communication. As such, if the wireless link is optical in nature, the antenna 68 may be replaced, for example, by a photo diode and/or a photo sensor.

The signal processing element 50 may be capable of mixing input video signals via the signal modification element 64 and displaying modified images corresponding to a result of the modifying (e.g., a modified video signal) at the display 60. In an exemplary embodiment, the modified video signal used to drive the display 60 may produce an unintelligible display to any viewer without the translation device 52. The signal modification element 64 may be embodied as any device or means embodied in either hardware, software, or a combination of hardware and software that is capable of modifying an input video signal to produce a modified video signal. The modification performed by the signal modification element 64 may include, but is not limited to mixing images on a frame-by-frame basis (sequential mix of several video streams), mixing an input image with a negative of the input image, polarizing an input image, applying a scrambling function (time and space dependant) to an input image to scramble the image, etc. or any combination of the above. The output of the signal modification element 64 (i.e., the modified video signal) may be used by the processing element 62 to drive the display 60. The processing element 62 may also communicate with the communication element 66 to enable the communication element 66 to communicate information regarding the modification performed on the input video signal to the translation device 52 to enable the translation device 52 to process image data optically received at the translation device 52 substantially back into the input video signal. The communication element 66 may be embodied as any device or means embodied in either hardware, software, or a combination of hardware and software that is capable of receiving and/or transmitting information at the signal processing element 50. As such, the communication element 66 may be capable of receiving information regarding the modification performed on the input video signal and thereafter transmitting the information received to the translation device 52 via the wireless link 70. Additionally, the communication element 66 may be capable of receiving requests or other information from the translation device 52 and communicating such requests to the processing element 62.

It should be noted that although the signal processing element 50 is illustrated as being separate from the display 60 in FIG. 2, the signal processing element 50 could also be included in a part of the display 60. Alternatively, the signal processing element 50 could be, for example, a modular attachment which a user may choose to place in communication with the display 60. As such, the communication element 66 may also be a part of the display 60, or as shown in FIG. 2, may be a part of a separate device or modular attachment including the signal processing element 50. Alternatively, the communication element 66 could also be included in yet another separate device or modular attachment. The signal processing element 50 could be, for example, a digital set top box or other similar device.

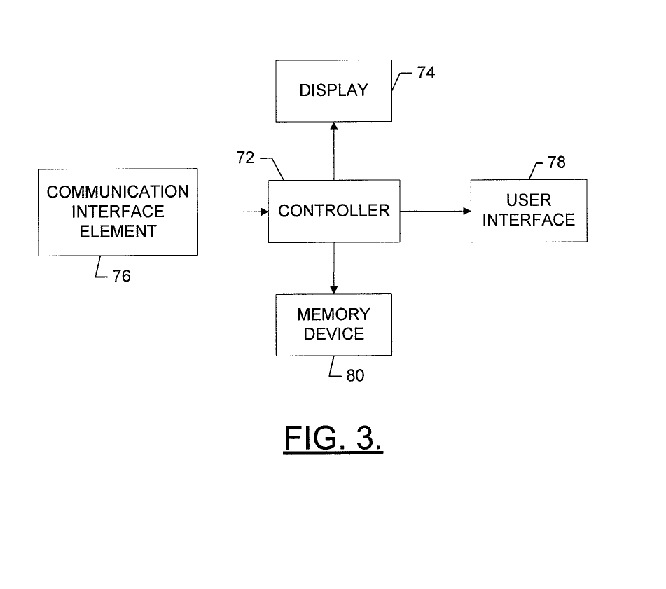

As shown in FIG. 3, the translation device 52 may include a processing element such as controller 72, a display 74, a communication interface element 76, and a user interface 78. Although not required, the translation device 52 may also include a memory device 80 which may be either volatile or non-volatile memory which could be used, for example, to buffer image data for processing by the translation device 52.

Processing elements described herein (e.g., controller 72 and processing element 62) may be embodied in many ways. For example, the processing elements may be embodied as a processor, a coprocessor, a controller or various other processing means or devices including integrated circuits such as, for example, an ASIC (application specific integrated circuit). In an exemplary embodiment, the controller 72 of the translation device 52 may be configured to execute instructions stored in the memory device 80 or otherwise accessible to the controller 72 in order to translate the modified video signal that is optically received by the communication interface element 76 into a restored video signal for output at the display 74. Meanwhile, the display 74 may be, for example, a conventional LCD, a projection display, optical elements having variable optical transmittance or any other suitable display upon which images such as video images may be rendered. In an exemplary embodiment in which the translation device 52 is the mobile terminal 10 of FIG. 1, the display 74 may be the LCD display of a mobile telephone. Meanwhile, in an exemplary embodiment in which the translation device 52 is a pair of goggles as shown in FIG. 2, the display 74 may be a projection onto a portion of, or an entirety of, a lens portion of the goggles. Any other suitable display may also be employed such as a translation device in a phone and projection at goggles.

The communication interface element 76 may be embodied as any device or means embodied in either hardware, software, or a combination of hardware and software that is capable of receiving optical image data and converting the optical image data into digital data and/or receiving wireless communications from the signal processing element 50. As such, the communication interface element 76 may include hardware and/or software for optically receiving input image data and converting such optically received input image data into digitized image data. In this regard, the communication interface element 76 may include, for example, the camera module 36 of FIG. 1 or any other combination of image capturing software and/or hardware such as lenses, analog to digital converters, encoders, etc. that may be known in the art. The communication interface element 76 may also include, for example, an antenna and/or receiver for receiving transmissions from the transmission element 66 of the signal processing element 50 regarding the modification performed on the input video signal.

The user interface 78 may include, for example, a keyboard, keypad, function keys, or any other mechanism by which a user may interface with the translation device 52. In an exemplary embodiment, the user may utilize the user interface 78, for example, to requisition information regarding the modification performed on the input video signal, to select a level of security or type of modification to be performed on the input video signal or various other user selections.

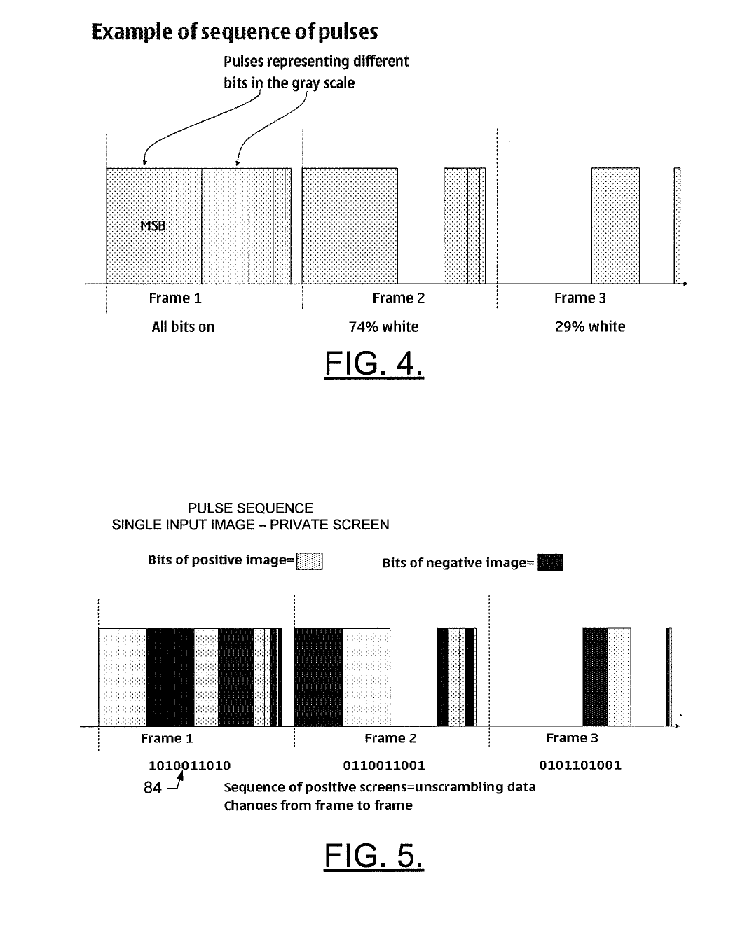

According to an exemplary embodiment of the present invention, the modification element 64 may be configured to provide video data as a series of pulses representing different bits in the gray scale in each frame of a video signal as shown in FIG. 4. In general, the signal processing element 50 receives at least one input video signal and modifies the input video signal to produce a modified video signal which is used to drive the display 60. The translation device 52 (e.g., goggles, camera device, cell phone, video recorder, etc.) may then be trained on the display 60 such that the translation device 52 is capable of communication with the display 60 and capable of optically capturing or receiving images displayed on the display 60 in order to receive the information displayed thereon. The signal processing element 50 also provides security information to the translation device 52 via the wireless link 70. The optically received information, which is resultant from the display of the modified video signal, may then be processed at the translation device 52 in a manner indicated by the security information in order to enable the translation device 52 to restore the modified video signal to produce a restored signal which, when used to drive the display 74 of the translation device 52, produces a video output substantially similar to that which the input video signal would have produced without modification.

Privacy in consumption of the information output by the signal modification element 64 may be achieved by applying a privacy operation to the video data. In this regard, the signal modification element 64 may be configured to provide a scrambled or encoded video signal as an output in response to receipt of at least one input video signal. In other words, the modified video signal produced by the signal modification element 64 may be a scrambled or encoded version of the input video signal. The privacy operation may be, for example, a time based multiplexing operation or a wavelength based multiplexing operation, or any other scrambling or encoding operation. For example, in the case of wavelength multiplexing, light sources may be utilized which have narrow bands and content may be scrambled between different bands.

In an exemplary embodiment in which time based multiplexing is performed, the scrambling or encoding may be performed by mixing bits of positive image (i.e., an image in which light areas of the image are rendered as light and dark areas are rendered as dark) with bits of negative image (i.e., an image in which light areas of the image are rendered as dark and dark areas are rendered as light) for each frame of a video stream as shown in FIG. 5. Thus, for example, when the bits of positive and negative image are mixed, the resultant video data will produce a substantially unintelligible result when displayed at the display 60. The exemplary embodiment of FIG. 5 may be useful, for example, in situations in which a single user desires to consume video information in a private manner. For example, the display 60 may appear to a viewer as a blank or fuzzy screen. Accordingly, by providing the bits of positive image along with the bits of negative image, the unaided human eye will not perceive the video information which the user may then consume privately using the translation device 52. The translation device 52 may be enabled to restore the mixed images to intelligible video data since the translation device 52 can be synchronized with the signal processing element 50 in order to process only the positive image data. In an exemplary embodiment, goggles may be configured to open only during transmission times when positive image bits are transmitted. Alternatively, the translation device 52 may discard or ignore the negative image data and only process the positive image data. In any case, the translation device 52 receives the security information which is indicative of the privacy operation applied so that the translation device 52 may restore the mixed images.

In an exemplary embodiment, the security information may include synchronization data 84 that may be transmitted by the communication element 66 to the translation device 52 via the wireless link 70 in order to inform the translation device 52 as to during which time periods the positive image data may be received and thus, during which time periods the translation device 52 should be open to data receipt or processing of data. The synchronization data 84 may be sent continuously from the signal processing element 50 to the translation device 52, for example, via a low bit rate channel integrated into the translation device 52 for communicating security information. The low bit rate channel could be, for example, either an RF channel, an optical channel or an infrared (IR) channel. Thus, in general, the synchronization data 84 may provide timing information regarding the sequences of pulses which the translation device 52 will be receiving (i.e., a synchronization log). In an exemplary embodiment, the synchronization data 84 may include timing information and a periodically transmitted reset pulse in order to ensure that if a drop off occurs, synchronization may be restored. In this regard, the synchronization data 84 could be provided as a high security option when utilized as a real time function that is continuously transmitted.

Alternatively, the synchronization data 84 may be communicated upon initial setup of a video session and then be transmitted periodically thereafter. As such, the synchronization data 84 may be a regularly updated function in order to provide a lower security alternative. In various exemplary embodiments, the period at which synchronization data 84 including reset pulses may be transmitted by the signal processing element 50 may be any desired interval (e.g., once per minute). In one exemplary embodiment, the user may utilize the user interface 78 in order to select the desired interval. Alternatively, the user may select between the real time function and the regularly updated function.

In an exemplary embodiment, the order of the frames of the input video image may be altered by the privacy operation in order to scramble the ordering of the frames. As such, the security information may also include information related to the ordering of the frames such that the information optically received at the translation device 52 may be restored utilizing the security information which includes information related to the ordering of the frames.

Although the embodiment described above with regard to FIG. 5 may be utilized for private viewing of the input video signal, other embodiments of the present invention may alternatively be employed. For example, the signal modification element 64 may be configured to modify the input video signal using other forms of privacy operations. For example, the input video signal may be processed at the signal modification element 64 such that a sub frame is scrambled by providing left polarization to an image and immediately thereafter providing right polarization to a negative of the image of the sub frame. The order of polarization of each sub frame may be set according to a predetermined or pseudorandom scrambling sequence. The scrambled sequence of frames may then be displayed as a screen that appears essentially as a white screen to the unaided human eye. However, a code for descrambling each of the sub frames may be transmitted to the translation device 52 which may cause polarization switching of the display 74 such that only the actual images of the input video signal are perceived through the translation device 52.

For example, the translation device 52 may be embodied as goggles employing a flickering layer or filter which is synchronized with the signal processing element 50 via the wireless link 70. Accordingly, consistent video information may be viewed through the goggles since a receiving system of the goggles may be synchronized to control the optical transmittance of a polarizer layer of the lenses of the goggles to correspondingly to open or close the lenses at respective times in order to produce an intelligible output at the display 74 of the translation device 52. In an exemplary embodiment, the security information may be transmitted to the translation device 52 once upon or prior to initial operation and, if desired periodically thereafter in order to provide synchronization between the signal processing element 50 and the translation device 52. In an exemplary embodiment, the security information may be transmitted by the signal processing element 50 in response to the signal processing element 50 sensing that the translation device 52 is in its proximity (e.g., by a Bluetooth scan) by any suitable method. Alternatively, the security information may be sent by the signal processing element 50 in response to a requisition request from the translation device 52. Accordingly, for example, the display 60 may display a signal corresponding to the modified video signal which is unintelligible to the unaided eye. The display 60 may also periodically display or have posted nearby, instructions for requisitioning the security information in order to enable the translation device 52 to produce restored images from the images displayed at the display 60. The user or viewer may then, for example, place a call to a service center or otherwise subscribe to a service which thereby grants access to view a particular channel of the signal processing element 50.

Thus, a viewer or user of the translation device 52 may privately consume image data related to the input video signal. The user of the translation device 52 (and/or the operator of the signal processing element 50) may share the security information with other users of translation devices in order to enable the other users to consume the image data as well. Thus, as shown in FIG. 5, a single user or multiple users may privately consume video images related to a single input video signal.

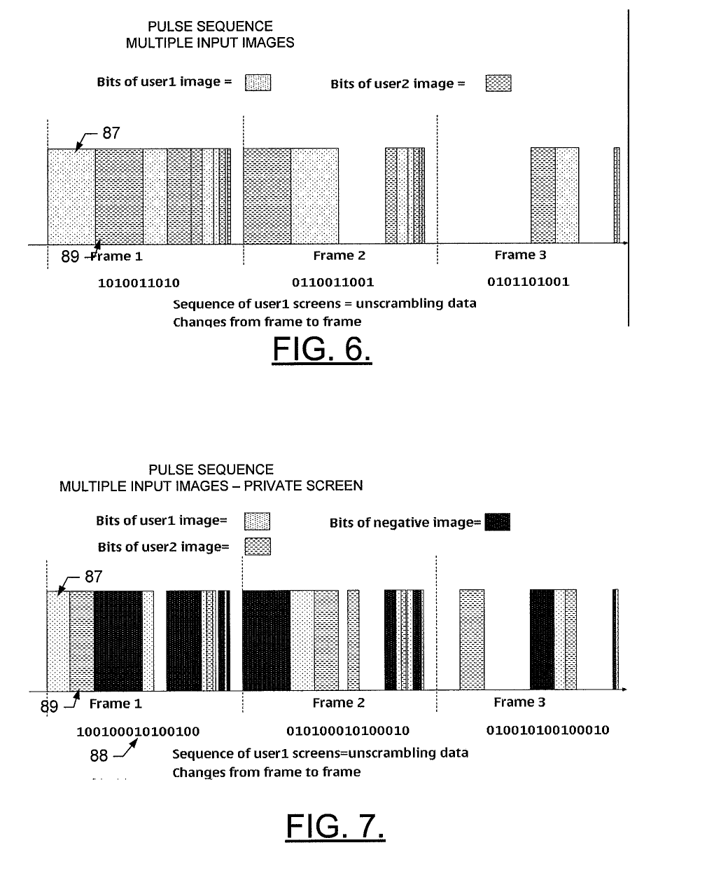

FIG. 6 shows an illustration of data related to a series of image frames of a modified video signal associated with more than one input image signal according to an exemplary embodiment of the present invention. Although FIG. 5 referred mainly to operation for enabling private consumption of video images related to a single input video signal, embodiments of the present invention may also be applied to multiple input video signals being multiplexed and displayed simultaneously on a single display using methods described in reference to FIG. 6.

Referring now to FIG. 6, scrambling of input images may be performed, for example, by varying the order of frames from different video streams, as described above, and transmitting a scrambling function which may include both synchronization and timing signals as also described above. However, as shown in FIG. 6, more than one input video signal may be provided. Accordingly, more than one user (e.g., user 1 and user 2) may view corresponding different video images via their corresponding translation devices in response to receipt of corresponding security information including synchronization and timing information related to the corresponding different video images and/or information related to the privacy operation performed on each of the corresponding different input video signals. In fact, mixing of the images corresponding to the different video streams may itself provide some amount of security since the images rendered on the display may appear as a overlapping of the two (or more) input video signals.

For example, bits of user 1 image data 87 for each frame of a first input video signal may be mixed with bits of user 2 image data 89 for each frame of a second input video signal. The security information including, for example, synchronization data 88 for the first input video signal, may be communicated to the translation device of user 1 in order to inform the translation device of user 1 as to which pulses transmitted correspond to data related to the first input video signal. Accordingly, the translation device of user 1 may process only the data associated with the first input video signal. The security information may also include a scrambling function associated with the first input video signal, if applicable. Thus, the translation device of user 1 may unscramble, decode or otherwise process the information related to the first input video signal in order to produce a restored first input video signal for display at the display of the translation device of user 1. The translation device of user 2 may operate substantially similar to the operation of the translation device of user 1 described above. In order to add further security, bits of negative image may also be mixed with the data of the first and second input video signals as shown, for example, in FIG. 7.

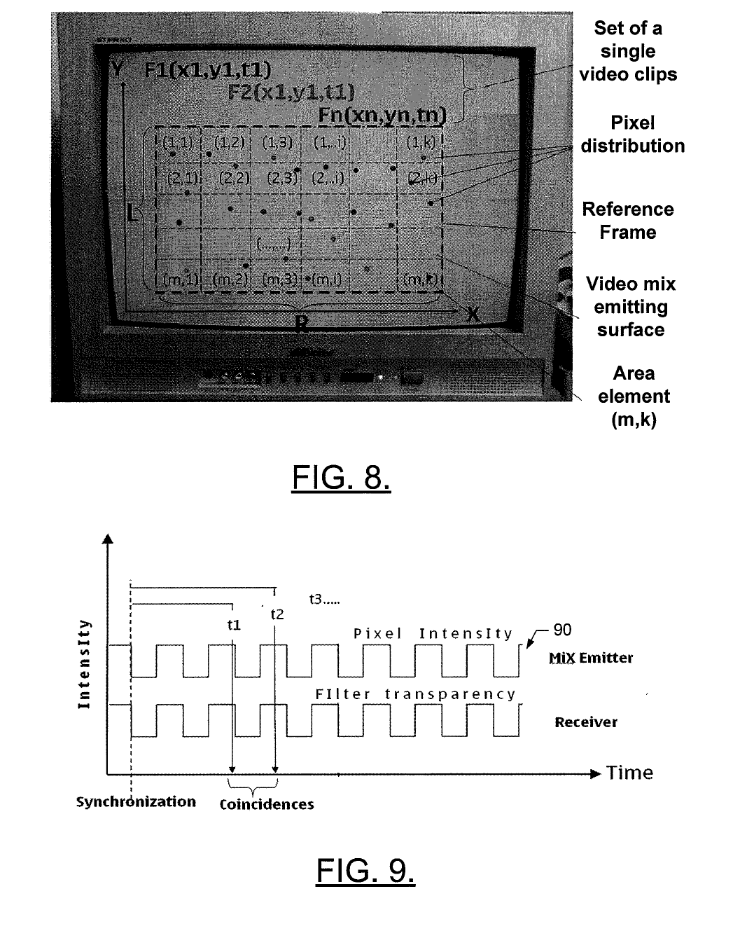

In another exemplary embodiment, a pixel distribution of the input video signal may be scrambled according to a scrambling function. The scrambling function may then be communicated to the translation device 52 to enable the translation device 52 to optically receive input images and descramble the input images based on the scrambling function in order to produce the restored video signal and drive the display 74 of the translation device 52 to produce restored images. As shown in FIG. 8, the first input video signal may be defined as a sequence of subsequent pixel patterns or a sequence of video frames F1(x,y,t), where 1 is an index of a single consistent image, x,y are particular pixels within a single image and t is time. The second input video signal may then be described by F2(x,yt). Additionally, yet further input video signals may be described by Fn(x,y,t). Thus, for example, a single image of the first input video signal at time t1 may be defined as F1(x1,y1,t1). A mix of the input video signals (F1, F2 . . . Fi . . . Fn) may be accomplished by a relatively simple algorithm at the signal modification element 64 and then, if desired, a scrambling algorithm Sc may be applied to provide further security. The scrambling algorithm Sc may be chosen depending upon the desired level of security or privacy by utilizing more complex functions for the scrambling algorithm Sc in order to scramble the input video signals by Sc=f(F1, F2 . . . Fi . . . Fn, t). To improve stability of an unscrambling procedure a reference frame (see FIG. 8) may be utilized to provide automatic alignment between emitting and receiving devices (anti-shaking algorithm). The simplest geometrical shapes can be utilized to align the reference systems and reference points, e.g., rectangular frames around the emitting display or straight lines.

As shown in FIG. 8, in an exemplary embodiment, a matrix of area elements (e.g., (1,1) to (m,k)) may define a display of a video mix emitting surface displaying a reference frame. As such, in one embodiment, only a portion of the pixels may be scrambled over finite area elements. In other words, it is not required to scramble all of the pixels.

In addition automatic scaling and division into certain number of the area elements (m,k) can be performed in a pre determined way by using a L/R ratio (height over length) of the reference frame, see FIG. 8. The same division ratio L/R can be used in a receiver device to provide good and automatic alignment between the edges of area elements in the receiver device.

As stated above, the scrambled input video signal (i.e., the modified video signal) may then be used to drive the display 60. The translation device 52 may optically receive the output of the display 60 and the security information corresponding to the desired signal (i.e., F1, F2 . . . Fi . . . Fn) via the wireless link 70. As stated above, the wireless link 70 may be a low bit rate wireless channel which may be provided using, for example, Bluetooth, IR or a photo sensor, RFID or just a SMS/MMS. Using the security information including information regarding the scrambling function used to scramble the input video signals, the translation device 52 may unscramble the modified video signal to extract and display information corresponding to the desired signal at the display 74. The security information may be provided continuously or, in order to reduce power consumption requirements, at a periodic interval (e.g., every 10 seconds).

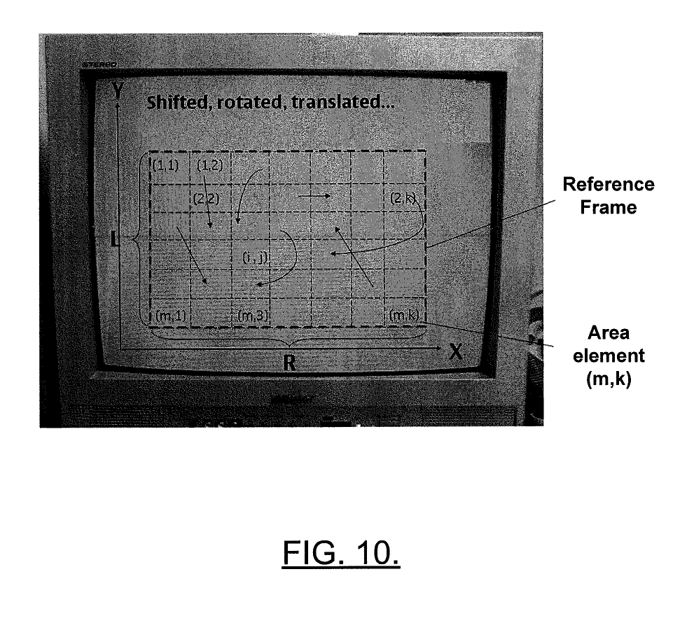

In an exemplary embodiment, the scrambling algorithm Sc may be based only on time dependence Sc(t). For example, as shown in FIG. 9, selection of an appropriate image may be obtained by configuring the translation device 52 to alter filter transparency in response to time coincidences and synchronization between the intensity of security information transmitted by the communication element 66 as indicated by mix emitter signal 90 and filter transparency. As such, after the initial synchronization, the filter transparency will be altered at respective times in order to correspond to the pixel intensity of the mix emitter signal 90 in a manner similar to that described above. Alternatively, as shown in FIG. 10, matrix of area elements (m,k) pixel transformation scrambling functions may be utilized. In this regard, position rotation, pixel shift and other transformation or scrambling methods may be utilized in order to provide higher levels of security when performing the privacy operation on an input video signal.

In an exemplary embodiment, a low bit rate channel communication may be established between the signal processing element 50 and the translation device 52 embodied as a mobile terminal 10 of FIG. 1. Alternatively, the translation device 52 could be goggles or any other suitable device. However, in an exemplary embodiment, both goggles and a mobile terminal could be employed. For example, the mobile terminal could be in communication with the signal processing element 50 via the low bit rate channel and the mobile terminal may subsequently communicate information related to complex security information to the goggles (since, for example, goggles may not possess communication sufficient capabilities to process complex security information) via a wired or wireless (e.g., Bluetooth) connection. The goggles may then, for example, alter optical transmittance properties of the display 74 (i.e., lenses of the goggles) in accordance with the security information. The mobile terminal may also receive and output audio information and/or control data related to the video displayed at the goggles. The mobile terminal may receive streamed audio information and/or control data via, for example, Bluetooth, Wibree, Ultra-wideband (UWB), etc., for output using a headset or other audio output device. In an exemplary embodiment, different information could be provided to lenses associated with right and left eyes of the goggles, respectively. If desired, the left and right images may be scrambled differently such that different security information is provided for left and right images. Accordingly, for example, three dimensional images may be viewed through the goggles.

Another exemplary embodiment may be employed in the context of location based or intelligent advertising. For example, a user may receive tailored and private advertising based on the user's location. In this regard, each user may be associated with a user profile that may be indicative of types of products the user may be interested in purchasing. The user profile may be created by the user in response to questions used to create the user profile, or the user profile may be created based on information of past purchases made by the user. Accordingly, when the user is determined to be at a particular location having, for example, a public display screen, location based messaging may be provided to the user which may include a scrambling script for enabling the user to view a corresponding advertisement on the public display screen. The user's location may be determined, for example, via Bluetooth peer detection, GPS positioning, RFID sensing, etc. Accordingly, in response to the personalized advertising, the user may elect to purchase products either by physically selecting the products for payment within a store, or by purchasing the products wirelessly over a web connection via the mobile terminal.

In yet another exemplary embodiment, pay-per-view options may be provided for viewing of media. In this regard, a user of the translation device 52 may be enabled to purchase media content and then have the media content delivered privately, even in a public place. Such pay-per-view viewing may be provided, for example, in hotels, homes, or other environments. In an exemplary embodiment, the user may be enabled to preview a portion of the content before deciding to purchase the content.

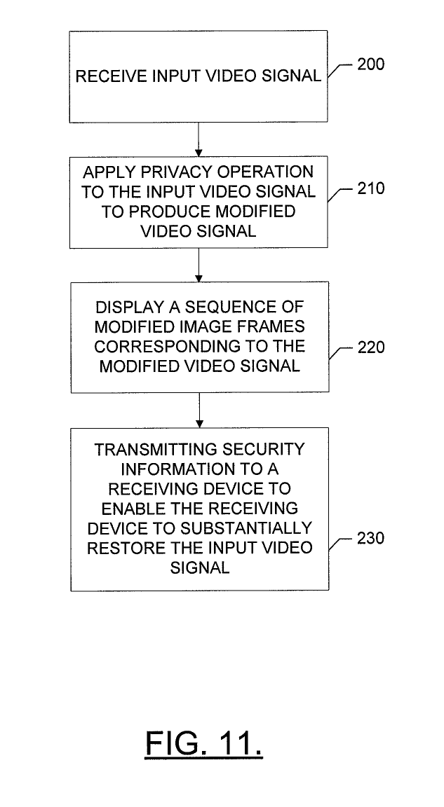

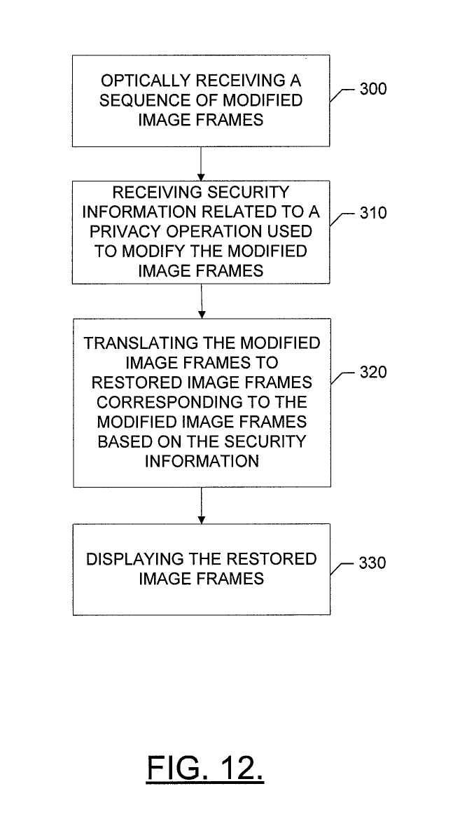

FIGS. 11 and 12 are flowcharts of systems, methods and program products according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the translation device and/or the signal processing element and executed by a built-in processor in the translation device and/or the signal processing element, respectively. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing a private video screen, as shown in FIG. 11, may include receiving an input video signal at operation 200. At operation 210, a privacy operation may be applied to the input video signal to produce a modified video signal. A sequence of modified image frames corresponding to the modified video signal may be displayed at operation 220. At operation 230, security information may be transmitted to a receiving device to enable the receiving device to substantially restore the input video signal. In an exemplary embodiment, operation 200 may include receiving at least a first input video signal and a second input video signal. Meanwhile, operation 210 may include mixing the first and second input video signals. Alternatively, operation 210 may include mixing positive image data corresponding to the input video signal with negative image data corresponding to the input video signal within each frame of the input video signal or scrambling a frame order of the input video signal. In an alternative embodiment, operation 210 may include applying a scrambling function to the input video signal to perform a pixel transformation on pixels of the input video signal. Operation 230 may include, for example, transmitting information regarding the privacy operation used to modify the input video image, or transmitting synchronization data to synchronize operation of the receiving device with the modified video signal to enable the receiving device to substantially restore the input video signal.

Another embodiment of a method of providing a private video screen, as shown in FIG. 12, may include optically receiving a sequence of modified image frames at operation 300. At operation 310, security information related to a privacy operation used to modify, or associated with, the modified image frames may be received. The modified image frames may be translated to restored image frames corresponding to the modified image frames based on the security information at operation 320. At operation 330, the restored image frames may be displayed. In an exemplary embodiment, operation 300 may include receiving mixed image frames corresponding to at least a first input video signal and a second input video signal. Operation 310 may include receiving information regarding the privacy operation used to modify the input video image or receiving synchronization data to synchronize optically receiving selected frames among the modified image frames. Meanwhile, operation 320 may include providing the restored image frames using the selected frames or providing the restored image frames using the selected frames according to an order supplied in the security information.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
applying a privacy operation to an input video signal to produce a modified video signal;
displaying, for receipt at a receiving device, a sequence of modified image frames corresponding to the modified video signal; and
transmitting security information to the receiving device to enable the receiving device to substantially restore the input video signal.

2. A method according to claim 1, wherein receiving the input video signal comprises receiving at least a first input video signal and a second input video signal, and wherein applying the privacy operation comprises mixing the first and second input video signals.

3. A method according to claim 2, wherein applying the privacy operation comprises mixing positive image data corresponding to the first input video signal and the second input video signal with negative image data corresponding to at least one of the first or second input video signals within each frame of the input video signal.

4. A method according to claim 1, wherein applying the privacy operation comprises mixing positive image data corresponding to the input video signal with negative image data corresponding to the input video signal within each frame of the input video signal.

5. A method according to claim 1, wherein applying the privacy operation comprises scrambling a frame order of the input video signal.

6. A method according to claim 1, wherein applying the privacy operation comprises applying a scrambling function to the input video signal to perform a pixel transformation on pixels of the input video signal.

7. A method according to claim 1, wherein transmitting the security information comprises transmitting information regarding the privacy operation used to modify the input video image.

8. A method according to claim 1, wherein transmitting the security information comprises transmitting synchronization data to synchronize operation of the receiving device with the modified video signal to enable the receiving device to substantially restore the input video signal.

9. A computer program product comprising at least one computer-readable storage medium having computer-readable program code portions stored therein, the computer-readable program code portions comprising:
a first executable portion for applying a privacy operation to an input video signal to produce a modified video signal;
a second executable portion for displaying, for receipt at a receiving device, a sequence of modified image frames corresponding to the modified video signal; and
a third executable portion for transmitting security information to the receiving device to enable the receiving device to substantially restore the input video signal.

10. A computer program product according to claim 9, further comprising a fourth executable portion for an initial operation of receiving at least a first input video signal and a second input video signal, and wherein the first executable portion includes instructions for mixing the first and second input video signals.

11. A computer program product according to claim 9, wherein the first executable portion includes instructions for mixing positive image data corresponding to the input video signal with negative image data corresponding to the input video signal within each frame of the input video signal.

12. A computer program product according to claim 9, wherein the first executable portion includes instructions for one of:
scrambling a frame order of the input video signal; or
applying a scrambling function to the input video signal to perform a pixel transformation on pixels of the input video signal.

13. A computer program product according to claim 9, wherein the third executable portion includes instructions for at least one of:
transmitting information regarding the privacy operation used to modify the input video image; or
transmitting synchronization data to synchronize operation of the receiving device with the modified video signal to enable the receiving device to substantially restore the input video signal.

14. An apparatus comprising:
a signal modification element configured to apply a privacy operation to an input video signal to produce a modified video signal;
a display in communication with the signal modification element and configured to display a sequence of modified image frames corresponding to the modified video signal for receipt at a receiving device; and
a communication element in communication with the signal modification element and configured to transmit security information to the receiving device to enable the receiving device to substantially restore the input video signal.

15. An apparatus according to claim 14, wherein the signal modification element is further configured to receive the input video signal comprising at least a first input video signal and a second input video signal, and to mix the first and second input video signals.

16. An apparatus according to claim 15, wherein the signal modification element is further configured to mix positive image data corresponding to the first input video signal and the second input video signal with negative image data corresponding to at least one of the first and second input video signals within each frame of the input video signal.

17. An apparatus according to claim 14, wherein the signal modification element is further configured to mix positive image data corresponding to the input video signal with negative image data corresponding to the input video signal within each frame of the input video signal.

18. An apparatus according to claim 14, wherein the signal modification element is further configured to:
scramble a frame order of the input video signal; or
apply a scrambling function to the input video signal to perform a pixel transformation on pixels of the input video signal.

19. An apparatus according to claim 14, wherein the communication element is further configured to:
transmit information regarding the privacy operation used to modify the input video image; or
transmit synchronization data to synchronize operation of the receiving device with the modified video signal to enable the receiving device to substantially restore the input video signal.

20. An apparatus according to claim 14, wherein the communication element is further configured to receive a request from the receiving device for transmission of the security information.

21. An apparatus comprising:
a communication interface configured to optically receive a sequence of modified image frames and security information related to a privacy operation associated with the modified image frames; and
a processing element in communication with the communication interface and configured to translate the modified image frames to restored image frames corresponding to the modified image frames based on the security information.

22. An apparatus according to claim 21, wherein the communication interface is further configured to receive information regarding the privacy operation used to modify the input video image.

23. An apparatus according to claim 21, wherein the communication interface is further configured to receive synchronization data to synchronize optical receipt of selected frames among the modified image frames.

24. An apparatus according to claim 21, wherein the communication interface is further configured to receive mixed image frames corresponding to at least a first input video signal and a second input video signal.

25. An apparatus according to claim 21, wherein the processing element is further configured to provide the restored image frames using the selected frames.

26. An apparatus according to claim 21, wherein the processing element is further configured to provide the restored image frames using the selected frames according to an order supplied in the security information.

27. An apparatus according to claim 21, wherein the apparatus is embodied in:
a mobile terminal; or
goggles.

28. An apparatus according to claim 21, wherein the communication interface is further configured to transmit a request for transmission of the security information.

29. An apparatus according to claim 21, further comprising a display for displaying the restored image frames, the display being in communication with the processing element.

30. An apparatus comprising a display device configured to:
receive a modified video signal including an input video signal altered according to a privacy operation; and
display, for optical receipt at a receiving device, a sequence of modified image frames corresponding to the modified video signal.

31. An apparatus according to claim 30, wherein the modified video signal comprises at least a first input video signal and a second input video signal mixed according to the privacy operation.

32. An apparatus according to claim 30, wherein the apparatus is embodied as a public display.

33. An apparatus comprising:
means for optically receiving a sequence of modified image frames;
means for receiving security information related to a privacy operation associated with the modified image frames; and
means for translating the modified image frames to restored image frames corresponding to the modified image frames based on the security information.

34. An apparatus according to claim 32, further comprising means for displaying the restored image frames.
